(19) United States
(12) Patent Application Publication
(10) Pub. No.: US 2009/0138532 A1
(43) Pub. Date: May 28, 2009

(54) METHOD OF FILE ALLOCATING AND FILE ACCESSING IN DISTRIBUTED STORAGE, AND DEVICE AND PROGRAM THEREFOR

(75) Inventors: Junichi YAMATO, Minato-ku (JP); Kousuke Nogami, Minato-ku (JP); Yoshiaki Sakae, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/274,871

(22) Filed: Nov. 20, 2008

(30) Foreign Application Priority Data
Nov. 22, 2007 (JP) 2007-303076

(51) Int. Cl. G06F 12/02; G06F 12/16

(52) U.S. Cl. 707/204; 707/205; 707/E17.01; 707/E17.032; 707/E17.044; 711/E12.001; 711/E12.002; 711/E12.103

(57) ABSTRACT

A distributed storage system including a plurality of storage units connected to a host through a network includes a file allocating member configured to allocate a file to a storage unit which a multicast message from the host reaches, a file name managing member configured to manage a file name of the file allocated to the storage unit, and a responding member configured to respond to an access request, sent in the multicast message, from the host designating the file name, and indicating one of the storage units as a destination of the request, which holds the file.

This application is based upon and claims the benefit of priority from Japanese patent application No. 2007-303076, filed on Nov. 22, 2007, the disclosure of which is incorporated herein its entirely by reference.

### BACKGROUND

1. Technical Field

Aspects of the present invention relate to techniques, systems and devices for accessing a file in a distributed storage system.

2. Description of the Related Art

A conventional distributed file system is shown in FIG. 2. When a file is accessed from a host 1, as shown in FIG. 3, a metaserver 5 (a file allocation managing server) first performs pathname resolution to locate a storage unit holding the file (Step S100) and, thereafter, accesses the file held in a storage unit 2 (a file server) (Step S101). And, the next operation waits for the arrival of a response (Step S102).

Further, in some cases, the function performed by the metaserver 5 (the file allocation managing server) is implemented as part of the storage unit 2.

In a distributed file system described in “Proceedings of the 57th National Convention of Information Processing Society of Japan, Vol. 1, pp. 99-102, October 5, Heisei 10 (1998)” (Hereinafter “Non-patent Document 1”), as shown in FIG. 4, the metaserver 5 performs pathname resolution (Step S200) and allocation resolution of a data block (Step S201), and thereafter, accesses data held in the storage unit 2 (Step S202) And, the next operation waits for the arrival of a response (Step S203).

On this point, similar to the techniques disclosed in Japanese Patent Laid-Open No. 2007-65751 (Hereinafter “Patent Document 1”) and Japanese Patent Laid-Open No. 2001-51890 (Hereinafter “Patent Document 2”), there are other techniques, each of which omits a metaserver performing pathname resolution by using a multicast operation.

According to a technique disclosed in Patent Document 1, a router has a function of providing access to a RAID (Redundant Arrays of Inexpensive Disks) module in which corresponding data is stored. Further, according to a technique disclosed in Patent Document 2, each storage unit has a function that knows which file in a virtualized storage system is stored therein.

That is, according to the techniques disclosed in Patent Documents 1 and 2, a router or a storage unit makes an access request from a host by using multicast techniques. To perform load distribution, a storage unit or a router is required to perform processing therefor.

The above-described techniques related to this application have at least the following two problems.

The first problem is that response quality is poor since there are a number of procedures required to perform data access in a distributed storage system. This is because it is necessary to perform procedures to determine which storage units have the data stored therein, before accessing the data.

The second problem is that, even though it may be possible to avoid determining which storage units have the requested data stored therein, in order to solve the first problem, a function dedicated to avoiding such a determination must be provided by the network or a storage unit. This is because a storage unit or a router controls the allocation of data.

### SUMMARY

An aspect of the present invention is to provide a method of file allocation and file access in a distributed storage system, capable of simplifying access procedures of the distributed storage system without a specialized function in a storage unit, and a device and a program therefor. Embodiments of the present invention also overcome disadvantages not described above. Indeed, embodiments of the present invention may not overcome any of the problems described above.

An aspect of the invention concerning a distributed storage system including a plurality of storage units connected to a host through a network includes a file allocating member configured to allocate a file to a storage unit which receives a multicast message from the host, a file name managing member configured to manage a file name of the file allocated to the storage unit, and a responding member configured to respond to an access request, sent in the multicast message, from the host designating the file name, and indicating one of the storage units as a destination of the request, which holds the file.

Also, an aspect of the invention concerning a distributed storage system including a plurality of storage units connected to a host through a network, wherein the distributed storage system performs access by using multicast messages without identifying the storage unit storing a file, wherein the storage units belong to at least one of the ranges of a plurality of multicast messages which reach within specified ranges to send requests. The system includes a file copy allocating member configured to allocate a copy of the file in each of the storage units which are reached by the multicast messages.

Another aspect of the invention concerns a method of managing a distributed storage system including a plurality of storage units connected to a host through a network includes a file allocating operation that includes allocating a file to a storage unit which a multicast message from the host reaches, a file name managing operation comprising managing a file name of the file allocated to the storage unit, and a responding operation comprising responding to an access request, sent in the multicast message, from the host designating the file name, and indicating one of the storage units as a destination of the request, which holds the file.

Yet another aspect of the invention concerns a method of managing a distributed storage system including a plurality of storage units connected to a host through a network, wherein the distributed storage system performs access by using multicast message without identifying the storage unit storing a file, wherein the storage units belong to at least one of the ranges of a plurality of multicast messages which reach within specified ranges to send requests. The method includes a file copy allocating operation comprising allocating a copy of the file in each of the storage units which is reached by the multicast messages.

Also, an aspect of the invention concerning a computer readable tangible memory containing a program of instructions for managing a distributed storage system, including a plurality of storages connected to a host through a network, to execute processes, includes a file allocating process comprising allocating a file to a storage unit which a multicast message from the host reaches, a file name managing process comprising managing a file name of the file allocated to the storage unit, and a responding process comprising responding to an access request, sent in the multicast message, from the host designating the file name, and indicating one of the storage units as a destination of the request, which holds the file.

Also, an aspect of the invention concerning a computer readable tangible memory containing a program of instructions for managing a distributed storage system, including a plurality of storages connected to a host through a network, to execute processes, wherein the distributed storage system performs access by multicast message without identifying the storage unit storing a file, wherein the storage units belong to at least one of the ranges of a plurality of multicast messages which reach within specified ranges to send requests, wherein includes a file copy allocating process comprising allocating a copy of each file in the storage units which each of the multicast messages reaches.

### BRIEF DESCRIPTION OF THE DRAWINGS

FIG. 1 is a diagram showing a basic configuration of an embodiment of the present invention.

FIG. 2 is a block diagram showing a configuration of a conventional storage system.

FIG. 3 is a flowchart showing a procedure for data access in a conventional storage system.

FIG. 4 is a flowchart showing another procedure for data access in a conventional storage system.

FIG. 5 is a flowchart showing a procedure for issuing a reading request from a host according to an embodiment of the present invention.

FIG. 6 is a flowchart showing a procedure for processing a reading request according to an embodiment of the present invention.

FIG. 7 is a flowchart showing a determination procedure for a storage unit being a destination for storing a file according to an embodiment of the present invention.

FIG. 8 is a flowchart showing a procedure for issuing a writing request from the host according to an embodiment of the present invention.

FIG. 9 is a flowchart showing a determination procedure for a re-allocation destination in which a storage unit is a destination for storing a file according to an embodiment of the present invention.

FIG. 10 is a flowchart showing another determination procedure in which a storage unit is a destination for storing a file according to an embodiment the present invention.

FIG. 11 is a flowchart showing another determination procedure for a re-allocation destination in which a storage unit is a destination for storing a file according to an embodiment of the present invention.

### DESCRIPTION OF EXEMPLARY EMBODIMENTS

Hereinafter, certain non-limiting embodiments of the present invention are described in detail with reference to the drawings.

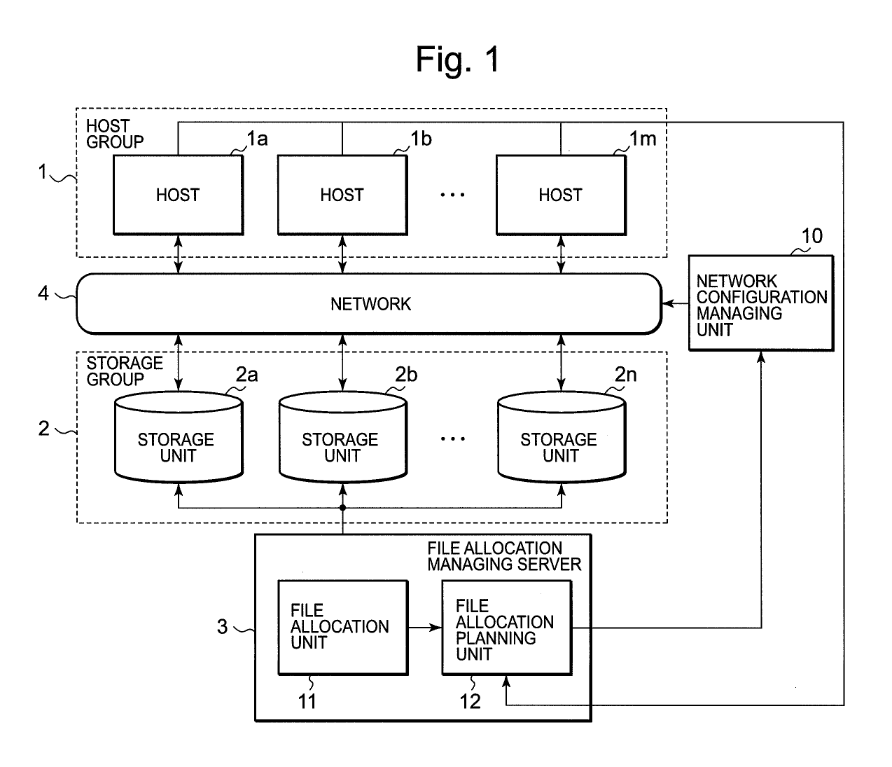

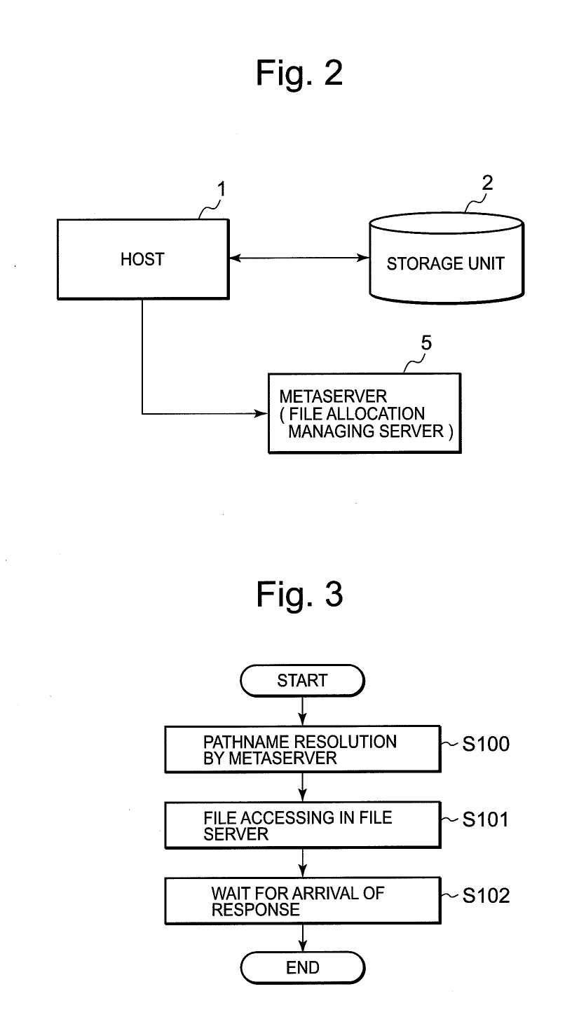

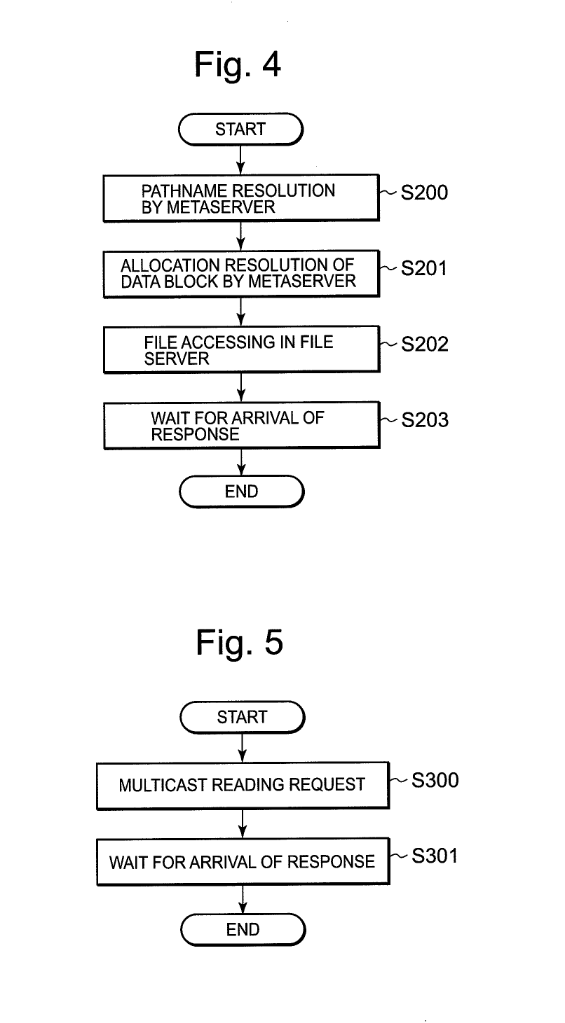

FIG. 1, shows an example of one embodiment of the present invention that includes a host group 1, a storage group 2, a file allocation managing server 3 which controls the allocation of data in the storage group 2, and a network 4 through which the host group 1 and the storage group 2 are connected.

The host group 1 is a group including hosts 1a to 1m on which a user program operates. The storage group 2 is a group including storage units 2a to 2n in which data to be used by the user program is stored.

Further, the file allocation managing server 3 includes a file allocation planning unit 12 which determines an allocation of a file to the storage group 2, and a file allocation unit 11 which controls a file allocation in the storage group 2.

The network 4, which is a network that is within a range of reach of a multicast message, is controlled by a network configuration managing unit 10.

The host group 1 includes computers on which user programs operate.

The storage group 2 includes storage units which store user data. And, the host group 1 is capable of accessing the user data stored in the storage group 2.

The storage units of storage group 2 includes storage devices such as magnetic storage devices or magneto-optical storage devices, and array devices thereof, which receive access requests from the host group 1 via the network 4. An example of a storage device includes a device such as a NAS (Network Attached Storage). Further, the storage group 2 locally manages file names (pathnames) of files stored therein.

The network 4 is a network such as an Ethernet (a registered trademark) network, which can transmit identical data to a plurality of nodes (storage units) by using IP multicast, VLAN, or the like. The multicast operation may be achieved by using VLAN and broadcast technologies. In addition, the multicast operation may be achieved in such a way that the host group 1 transmits data having the same contents to a plurality of storage units at approximately the same time, instead of the network 4 performing this function.

The network configuration managing unit 10 sets and stores a range of the multicast operation for the network 4. The network configuration managing unit 10 may be a part of the network 4, or may be a separate device from the network 4.

The file allocation managing server 3 is a computer which manages the allocation of files to the storage group 2.

The file allocation planning unit 12 is a unit which determines the allocation of files for the storage group 2.

The file allocation unit 11 is a unit which copies/deletes a file in cooperation with the file allocation planning unit 12, and thereby controls the allocation of files in the storage group 2.

In FIG. 1, although described as an independent device, the file allocation managing server 3 maybe apart of the storage group 2.

Next, a method of determining a range of a multicast operation according to an embodiment of the present invention is described.

A range of reach by each multicast operation is determined so that the number of storage units (nodes) to be reached in a multicast operation is equivalent. That is, when it is determined that a certain multicast operation reaches “N” number of storage units (nodes), the range of reach is so determined such that any multicast operation reaches “N” storage units (nodes). In addition, a setting for which multicast operations reach which storage units may be determined so as to be cyclically assigned, or determined using random numbers. However, storage groups which are reached by different multicast operations are determined not to be completely matched with each other. Further, each storage unit may be reached by a plurality of multicasts operations.

Further, the total capacity of the storage units reached by each multicast operation may be configured to exceed a total capacity of the entire data to be stored.

Further, as for a different method of determining a range for a multicast operation, from that described above, the storage group 2 which a multicast reaches may be configured so as to produce a throughput exceeding loads of storage accesses of the host group that uses the multicast operations. At this time, the numbers of storage units which each multicast operation reaches are not necessarily the same. Thus, it is possible to ensure that the storage units achieve access performance required by the hosts.

In addition, it is also possible to configure a multicast group so that no storage unit is reached by all the multicast operations. With such a configuration, it is possible to produce a multicast operation that does not cause a shortage of storage units that are reached by a multicast operation when a single storage unit is not able to be used.

Further, another method of determining a range of a multicast, the number of storage units reached by a multicast operation may be determined by a rate at which the number of the storage units accords with the number of hosts using the multicast.

Still further, the number of storage units reached by a multicast operation may be determined so that the number of storage units is proportional to the storage access load of a host group using a multicast group.

Next, operation of an embodiment of the present invention is described with reference to the drawings. Referring to FIG. 5, an operation, when the host group 1 reads out data from the storage group 2, is described first.

The host group 1 designates a pathname of a file being a target of reading out (Hereinafter, referenced as “reading target file”), an offset address, in a file, of a start position for reading out (Hereinafter, referenced as “offset address of a reading start position in a file”), and a size of the data to be read out (Hereinafter, referenced as “reading size”). Then, the host group 1 transmits a reading request to the storage group 2 by using a multicast operation (Step S300). The next operation waits for the arrival of response (Step S301), and then the operation of the host group 1 ends. In this embodiment, an access request is made by using a pathname of a file, an offset address of a reading start position in the file, and a reading size, so that it is possible not only to access the entire file but also provide access to only a part of the file.

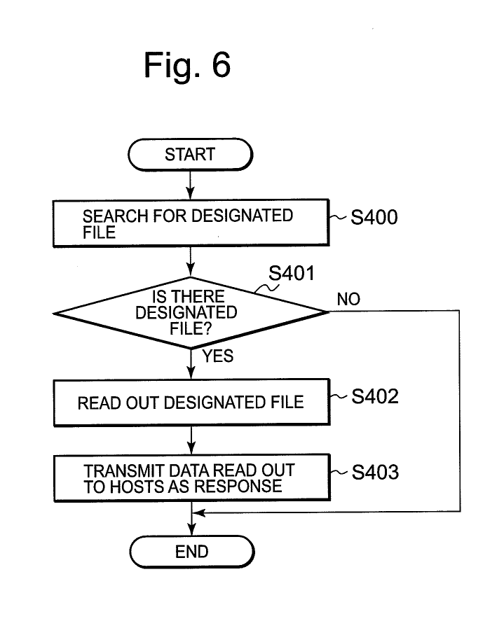

Subsequently, referring to FIG. 6, an operation of the storage group 2, when a reading request from the host group 1 arrives, is described.

When a reading request arrives from the host group 1, each storage unit of the storage group 2 performs a search of whether a file designated by the reading request exists in the storage unit (Step S400). When the designated file exists in the storage unit, the process moves to Step S402, and when the designated file does not exist in the storage unit, the process ends (Step S401).

In Step S402, a file searched in Step S400 is read out based on a size and an offset address which are designated by the reading request (Step S402). Thereafter, the data thus read out is transmitted to the host group 1 as a response (step S403), and the operation ends.

Next, a determination method in which a file entity is allocated to the storage group 2, is described.

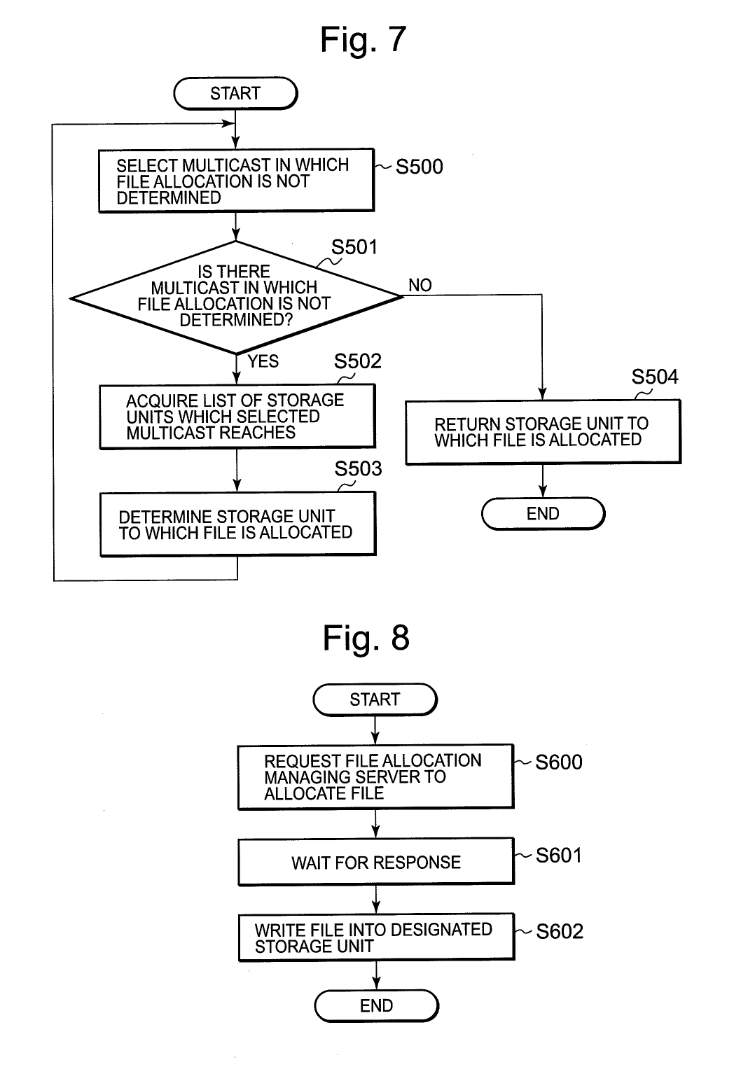

The allocation of a file is determined by the file allocation planning unit 12. Referring to FIG. 7, an operation, when a determination of allocation is requested to the file allocation planning unit 12, is described.

First, a multicast is selected in which file allocation has not been determined (Step S500). If there is no such multicast in which the allocation is undetermined, the process moves to Step S504, or, if there is a multicast in which the allocation is undetermined, the process moves to Step S502 (Step S501).

In Step S502, based on configuration information for a multicast acquired from the network configuration managing unit 10, a storage group, which the multicast selected in Step S500 reaches, is listed (Step S502).

In order to list a storage group which the multicast reaches in Step S502, the network configuration managing unit 10 includes a function that can determine the storage units (nodes) which the multicast reaches, and returns the list at the time of receipt of an inquiry. Further, storage units at which a multicast message arrives may be managed by a database or the like in a file allocation managing server, instead of managed by the network configuration managing unit 10.

Next, among such storage units listed in Step S502, a storage unit to which a file is allocated is determined using random numbers (Step S503), and the process moves again to Step S500.

In Step S504, the storage unit which has been determined as a destination, in which file allocation has already been determined, is returned to the network configuration managing unit 10, and the process ends (Step S504).

Next, referring to FIG. 8, an operation, when a file is written into a storage unit from a host in a system according to an embodiment of the present invention, is described.

The host group 1 transmits a request for determining a storage unit, into which a file is written, to the file allocation managing server 3 (Step S600).

Thereafter, the process waits for a response (Step S601), and the file is written into the storage unit designated by the file allocation managing server 3 (Step S602).

When the file allocation managing server 3 is requested to determine a storage unit, into which a file is written, from the host group 1, the determination is made by using the above-mentioned determination method in which a file entity is allocated to the storage group 2, and then, the response is returned to the host group 1.

At this time, the allocation may be made only to a storage unit which the multicast message reaches and, thereafter, a copy of the file may be made by a re-allocation of the file copy. When successively performing Step S602 on a storage unit by storage unit basis, it is possible to shorten the response time of a writing process in the manner described above. In addition, by performing a writing process on two or more storage units, it becomes possible to reduce the possibility of losing data when some kind of trouble occurs on a storage unit.

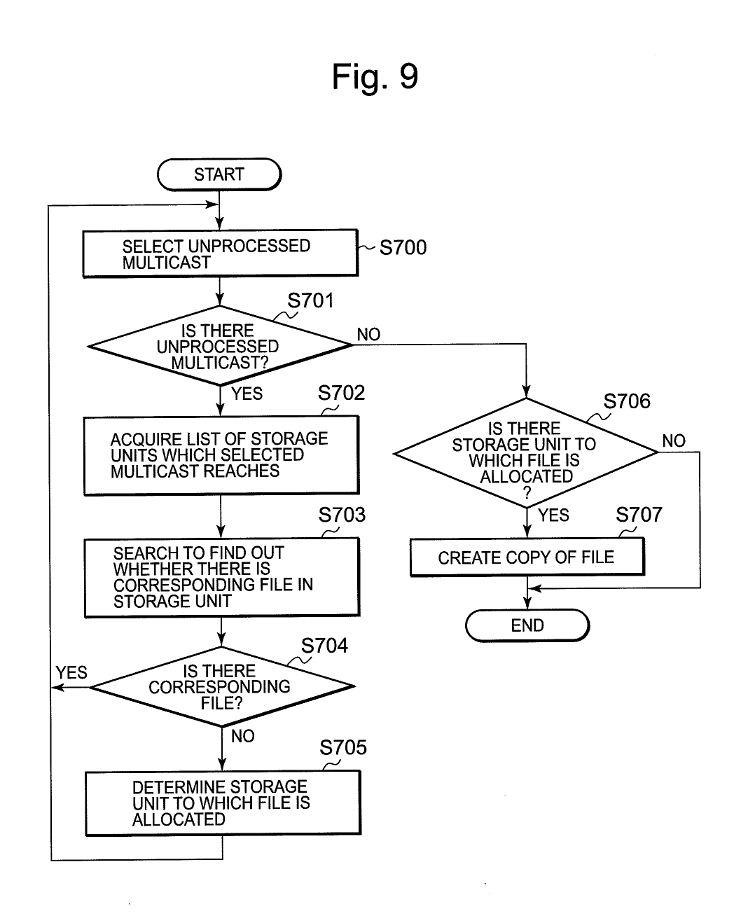

Referring to FIG. 9, a method of re-allocation of a copy of a file in the file allocation managing server 3, is described.

First, the file allocation planning unit 12 makes a selection of an unprocessed multicast (Step S700). If there is an unprocessed multicast, the process moves to Step S702, or, if there is no unprocessed multicast, the process moves to Step S706 (Step S701).

In Step S702, the file allocation planning unit 12 lists a storage group that a multicast selected in Step S700 reaches based on configuration information of a multicast acquired from the network configuration managing unit 10 (Step S702).

In order to list a storage group that the multicast reaches in Step S702, the network configuration managing unit 10 may determine storage units (nodes) which the multicast reaches, and return the list at the time of receipt of an inquiry. Further, storage units at which a multicast message arrives may be managed by a database or the like in a file allocation managing server, instead of managed by the network configuration managing unit 10.

Next, a search is performed to find out whether a corresponding file is stored in the storage units listed in Step S702 (Step S703). When the corresponding file is determined to be stored, the process moves to Step S700, and when the corresponding file is determined not to be stored, the process moves to Step S705 (Step S704).

In addition, the file allocation managing server 3 may manage the allocation of files for each storage unit, so that it can be checked whether the corresponding file is stored in storage units in Step S704.

Further, instead of being managed by the file allocation managing server 3, the system may be configured to check whether the corresponding file is stored in the storage units by inquiring of corresponding storage units. In this method, it is not necessary for the file allocation managing server 3 to determine which file is stored in each storage unit. In other words, there is an advantage that it is not necessary to provide a member which constantly determines the allocation of files in the entire system.

In Step S705, among storage units listed in Step S702, a storage unit to which a file is allocated is determined by using random numbers, and the process moves to Step S700.

In Step S706, if there is a storage unit to which a file is allocated, the process moves to Step S707, or, if there is no storage unit to which a file is allocated, the process ends.

In Step S707, the file allocation planning unit 12 instructs the file allocation unit 11 to copy the corresponding file onto the storage unit determined in Step S705. After completion of the copy, the process ends.

Next, an operation, in the case where some of the storage units of the storage group 2 are disabled due to a fault or the like in the storage group 2 in a system according to an embodiment of the present invention, is described.

The network configuration managing unit 10 changes the configuration of the network so that a range of communication of a multicast operation which reaches a disabled storage unit is changed to another range so that communication of the multicast does not reach the disabled storage. Accordingly, even when a disabled storage unit occurs, access to data is secured.

Alternatively, a host using a multicast operation which reaches a disabled storage unit may change the multicast operation to another multicast operation that does not reach the disabled storage. This method also secures access to data even when a disabled storage unit occurs.

Further, even when a disabled storage unit occurs due to a fault, file copies are re-allocated in the file allocation managing server 3 with respect to all the files, and thus all the files are made accessible within the ranges of communication of all multicasts. After completion of the re-allocation, a range of communication of a multicast used by the host or a multicast used by the host is restored. Thus, all the files are to be accessible with respect to the multicast which reaches the disabled storage unit. Therefore, when a disabled storage unit occurs, the multicast operation to be used is changed, and thereby an imbalance of the load among the storage units is reformed.

In addition, as a way to deal with the case where some fault or the like occurs in the storage group 2, identical files may be allocated to two or more storage units among the storage units that a multicast operation reaches, when the file allocation determining unit 11 determines storage units in which copies of the file are allocated. Thus, even when a disabled storage unit occurs, access to all the files is secured without changing a multicast operation.

Another embodiment of the present invention is described below. The method for determining a storage unit as a destination for allocating a file by file allocation determining unit 11 is different from the method described in the above embodiment.

The allocation of a file to a storage unit being a destination for the allocation is determined by the file allocation planning unit 12.

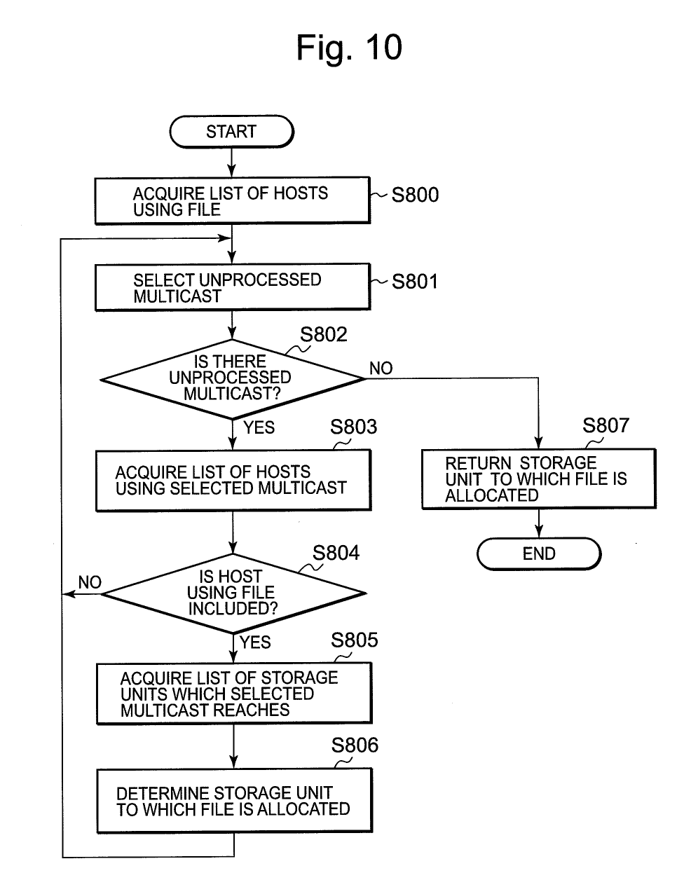

Operation of the file allocation planning unit 12 is described with reference to FIG. 10.

First, a list of hosts using a file is acquired (Step S800). In this embodiment, a host using a file is to be set in the system in advance. In order to determine a host which uses a file in Step S800, a list of hosts using the file is held in advance, such as in a database, in the file allocation managing server 3 or the like.

Next, a selection of an unprocessed multicast message is made (Step S801). If there is no unprocessed multicast message, the process moves to Step S807, or, if there is an unprocessed multicast message, the process moves to Step S803 (Step S802).

In Step S803, based on configuration information of a multicast message acquired from the network configuration managing unit 10, hosts which use the multicast message selected in Step S801 are listed (Step S803). In order to determine hosts which use the multicast message in Step S803, lists of the hosts that use the respective multicast messages are held, such as in a database, in the network configuration managing unit 10, in the file allocation managing server 3, or the like.

Thereafter, if the host group listed in Step S803 includes the host group listed in Step S800, the process moves to Step S805, or, if the host group listed in Step S803 does not include the host group listed in Step S800, the process moves to Step S801 (Step S804).

In Step S805, based on configuration information of a multicast acquired from the network configuration managing unit 10, storage groups reached by the multicast selected in Step S801 are listed (Step S805). In order to list the storage group 2 which the multicast reaches in Step S805, the network configuration managing unit 10 determines storage units (nodes) which the multicast reaches, and returns the list at the time of an inquiry.

Further, it is possible to manage storage units at which a multicast message arrives, by using a database or the like in the file allocation managing server 3, instead of using the network configuration managing unit 10.

Next, among such storage units listed in Step S805, a storage unit to which the file is to be allocated is determined using random numbers (Step S806), and the process moves to Step S801.

In Step S807, the determined storage unit is returned, and the process ends.

Thus, a copy of a file can be allocated only in a storage unit reached by a multicast which is used by a host using the file. That is, an efficiency of a capacity for each of the storage units is improved.

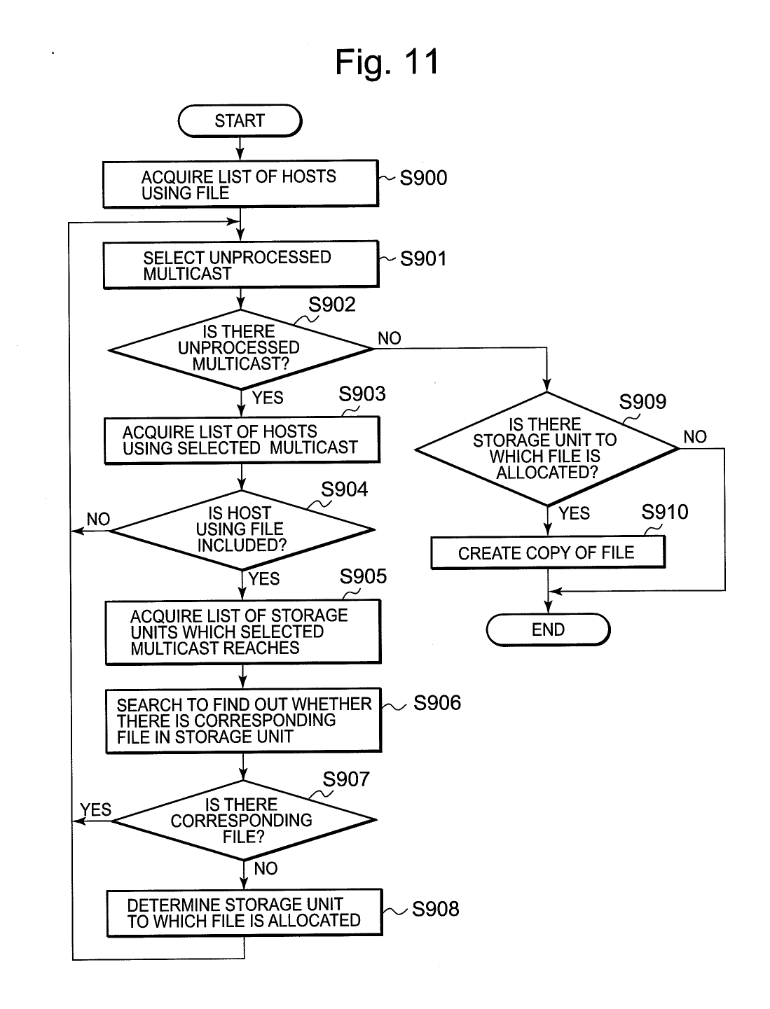

Next, referring to FIG. 11, an operation is described in which a copy of a file is re-allocated in a case where a host using a file is added, where a fault occurs in a storage unit, or where something similar thereto occurs.

First, a list of hosts using a file is acquired (Step S900).

Next, the file allocation planning unit 12 makes a selection of an unprocessed multicast message (Step S901). If there is an unprocessed multicast message, the process moves to Step S903, or, if there is no unprocessed multicast message, the process moves to Step S909 (Step S902).

In Step S903, based on configuration information of a multicast acquired from the network configuration managing unit 10, hosts which use the multicast selected in Step S901 are listed.

Next, if the hosts listed in Step S903 include the hosts listed in Step S900, the process moves to Step S905, or, the hosts listed in step S903 do not include the hosts listed in Step S900, the process moves to Step S901 (Step S904).

In Step S905, based on configuration information of a multicast acquired from the network configuration managing unit 10, a storage group which the multicast selected in Step S901 is listed.

Next, a search is performed to find out whether a corresponding file is stored in the storage units listed in Step S905 (Step S906). If the corresponding file is stored, the process moves to Step S901, or, if the corresponding file is not stored, the process moves to Step S908 (Step S907).

Next, among the storage units listed in Step S905, a storage unit to which the file is allocated is determined by using random numbers, and the process moves to Step S901.

In Step S909, if there is a storage unit to which the file is allocated, the process moves to Step S910, or, if there is no storage to which the file allocated, the process ends.

In Step S910, the file allocation unit 11 is instructed to copy the corresponding file onto the storage unit determined in Step S908. After completion of the copy, the process ends (Step S910).

Thus, a copy of a file can be allocated only in a storage unit which a multicast operation, used by a host using the file, reaches. That is, efficiency of a capacity for each of the storage units is improved.

An embodiment having the following configuration can perform the process Steps S900 to S910 described above.

In order to determine a host group which uses a file in Step S900, a list of hosts using the file is held, such as in a database, in the file allocation managing server 3 or the like.

In order to determine hosts using a multicast operation in Step S903, a list of hosts using the multicast operation is held, such as in a database, in the network configuration managing unit 10, the file allocation managing server 3, or the like.

In order to list the storage group 2 which a multicast reaches in Step S905, the network configuration managing unit 10 determines storage units (nodes) which the multicast reaches, and returns the list at the time of an inquiry. Further, a storage unit, at which a multicast message arrives, may be managed by using a database or the like in the file allocation managing server 3.

The file allocation managing server 3 manages the allocation of files to respective storage units, so that it can be checked whether a corresponding file is stored in storage units in Step S906.

Further, it may be checked whether a corresponding file is stored in storage units by inquiring of the corresponding storage group 2. In this method, it is not necessary for the file allocation managing server to determine which file is stored in the storage units. That is, it is not required that such a member constantly determines the allocation of files in the entire system.

Next, other embodiments are described of a determination method in which a file entity is allocated to the storage group 2 as well as of a determination method of a storage unit to which a file is allocated in a method of re-allocation of a copy of a file in the file allocation managing server 3. In these embodiments, a state of the load of a storage unit is considered.

A storage unit to which a file is allocated among storage group 2, in Step S503 of FIG. 7, Step S705 of FIG. 9, Step S806 of FIG. 10, and Step S908 of FIG. 11, may be the storage unit that has a lowest load based on the load history of the storage group 2.

Thus, it becomes possible to balance the load among storage units which a multicast reaches.

In addition, a storage unit to which a file is allocated among storage group 2, in Step S503 of FIG. 7, Step S705 of FIG. 9, Step S806 of FIG. 10, and Step S908 of FIG. 11, may be the storage unit that has the largest free space among units in the storage group 2.

Thus, it becomes possible to balance usable space among storage units that a multicast reaches.

Further, when a storage unit is determined, in Step S503 of FIG. 7, Step S705 of FIG. 9, Step S806 of FIG. 10, and Step S908 of FIG. 11, a file may preferentially be allocated to a storage unit that a plurality of multicasts reach.

Thus, it becomes possible to reduce the amount of space used in the entire storage group 2.

The embodiments of the present invention described above can produce the following advantages.

First, in a distributed storage system, it becomes possible to access a file without identifying the storage unit storing the file while not requiring that the storage unit has any special function.

This is because the file is allocated in the storage unit within a range where a multicast reaches, and information identifying the file is added to an access request, which is transmitted by the multicast operation.

Second, it becomes possible to achieve load balancing among storage units without requiring a storage unit to have a function for determining a state of the other storage units.

This is because, in a system in which an access request is transmitted to storage units from each host by using a multicast, a plurality of multicasts which reach different storage units from each other are set, and a multicast which is used by each host is selected. Thereby, load balancing is achieved.

Third, it becomes possible to secure access to a file while changing a range of a storage unit to be accessed by a plurality of multicasts. This is because a copy of each file is allocated in one or more storage units of the storage group 2 which each multicast reaches.

A file allocation device of a distributed storage system according to the above described embodiments can be implemented by hardware, software, or by a combination thereof.

While embodiments of the present invention have been described in detail above, it is contemplated that numerous modifications may be made to the above embodiments without departing from the spirit and scope of the embodiments of the present invention as defined in the following claims.

What is claimed is:

1. A distributed storage system including a plurality of storage units connected to a host through a network comprising:
a file allocating member configured to allocate a file to at least one of the storage units which receives a multicast message from the host;
a file name managing member configured to manage a file name of the file allocated to the storage units; and
a responding member configured to respond to an access request, sent in the multicast message, from the host designating the file name, and indicating one of the storage units as a destination of the request, which holds the file.

2. The distributed storage system according to claim 1 further comprising, a first writing member configured to write the file into any storage unit belonging to a storage group which the multicast message reaches.

3. The distributed storage system according to claim 1 further comprising, a second writing member configured to write the file into any storage unit belonging to a storage group which the multicast message, used by the host which uses the file, reaches.

4. The distributed storage system according to claim 1 further comprising, a first copy creating member configured to create a copy of the file in any storage unit belonging to a storage group which the multicast message reaches.

5. The distributed storage system according to claim 4, wherein the first copy creating member creates the copy of the file, if at least one storage unit belonging to the storage group is disabled.

6. The distributed storage system according to claim 4, wherein the first copy creating member creates the copy of the file stored in the storage unit belonging to a storage group which the multicast message, reaching a disabled storage, reaches, if at least one storage unit belonging to the storage group is disabled.

7. The distributed storage system according to claim 1 further comprising, a second copy creating member configured to create a copy of the file in any storage unit belonging to a storage group which the multicast message, used by the host which uses the file, reaches.

8. The distributed storage system according to claim 1 further comprising, a switching member configured to switch the multicast message used by the host to an alternate multicast message that does not reach a disabled storage unit, if at least one storage unit belonging to a storage group, which the multicast message reaches, is disabled.

9. A distributed storage system including a plurality of storage units connected to a host through a network, wherein the distributed storage system performs access by using a multicast message without identifying the storage unit storing a file,
wherein the storage units belong to at least one of the ranges of a plurality of multicast messages which reach within specified ranges to send requests,
the system comprising a file copy allocating member configured to allocate a copy of the file in the storage units which each of the multicast messages reaches.

10. A method of managing a distributed storage system including a plurality of storage units connected to a host through a network comprising:
a file allocating operation comprising allocating a file to a storage unit which a multicast message from the host reaches;
a file name managing operation comprising managing a file name of the file allocated to the storage unit; and
a responding operation comprising responding to an access request, sent in the multicast message, from the host designating the file name, and indicating one of the storage units as a destination of the request, which holds the file.

11. The method of managing a distributed storage system according to claim 10 further comprising, a first writing operation comprising writing the file into any storage unit belonging to a storage group which the multicast message reaches.

12. The method of managing a distributed storage system according to claim 10 further comprising, a second writing operation comprising writing the file into any storage unit belonging to a storage group which the multicast message, used by the host which uses the file, reaches.

13. The method of managing a distributed storage system according to claim 10 further comprising, a first copy creating operation comprising creating a copy of the file in any storage unit belonging to a storage group which the multicast message reaches.

14. The method of managing a distributed storage system according to claim 13, wherein the first copy creating operation further comprises creating the copy of the file, if at least one storage unit belonging to the storage group is disabled.

15. The method of managing a distributed storage system according to claim 13, wherein the first copy creating operation further comprises creating the copy of the file stored in the storage unit belonging to a storage group which the multicast, reaching a disabled storage, reaches, if at least one storage unit belonging to the storage group is disabled.

16. The method of managing a distributed storage system according to claim 10 further comprising, a second copy creating operation comprising creating a copy of the file in any storage unit belonging to a storage group which the multicast message, used by the host which uses the file, reaches.

17. The method of managing a distributed storage system according to claim 10 further comprising, a switching operation comprising switching the multicast message used by the host to an alternate multicast message that does not reach a disabled storage unit, when at least one storage unit belonging to a storage group, which the multicast message reaches, is disabled.

18. A method of managing a distributed storage system including a plurality of storage units connected to a host through a network,
wherein the distributed storage system performs access by using a multicast message without identifying the storage unit storing a file,
wherein the storage units belong to at least one of the ranges of a plurality of multicast messages which reach within specified ranges to send requests,
the method comprising a file copy allocating operation comprising allocating a copy of the file in each of the storage units which each of the multicast messages reaches.

19. A computer readable tangible memory containing a program of instructions for managing a distributed storage system, including a plurality of storages connected to a host through a network, comprising:
a file allocating process comprising allocating a file to a storage unit which a multicast message from the host reaches;
a file name managing process comprising managing a file name of the file allocated to the storage unit; and
a responding process comprising responding to an access request, sent in the multicast message, from the host designating the file name, and indicating one of the storage units as a destination of the request, which holds the file.

20. The computer readable tangible memory containing the program according to claim 19 further comprising, a first writing process comprising writing the file into any storage unit belonging to a storage group which the multicast message reaches.

21. The computer readable tangible memory containing the program according to claim 19 further comprising, a second writing process comprising writing the file into any storage unit belonging to a storage group which the multicast message, used by the host which uses the file, reaches.

22. The computer readable tangible memory containing the program according to claim 19 further comprising, a first copy creating process comprising creating a copy of the file in any storage unit belonging to a storage group which the multicast message reaches.

23. The computer readable tangible memory containing the program according to claim 22, wherein the first copy creating process further comprises creating the copy of the file, if at least one storage unit belonging to the storage group is disabled.

24. The computer readable tangible memory containing the program according to claim 22, wherein the first copy creating process further comprises creating the copy of the file stored in the storage unit belonging to a storage group which the multicast, reaching a disabled storage, reaches, if at least one storage unit belonging to the storage group is disabled.

25. The computer readable tangible memory containing the program according to claim 19 further comprising, a second copy creating process comprising creating a copy of the file in any storage unit belonging to a storage group which the multicast message, used by the host which uses the file, reaches.

26. The computer readable tangible memory containing the program according to claim 19 further comprising, a switching process comprising switching the multicast message used by the host to an alternate multicast message that does not reach a disabled storage unit, when at least one storage unit belonging to a storage group, which the multicast message reaches, is disabled.

27. A computer readable tangible memory containing a program of instructions for managing a distributed storage system, including a plurality of storage units connected to a host through a network,
wherein the distributed storage system performs access by using a multicast message without identifying the storage unit storing a file,
wherein the storage units belong to at least one of the ranges of a plurality of multicast messages which reach within specified ranges to send requests,
comprising a file copy allocating process comprising allocating a copy of the file in the storage units which each of the multicast messages reaches.

28. A file allocation managing apparatus used in a distributed storage system including a plurality of storage units connected to a host through a network comprising:
a file allocating member configured to allocate a file to a storage unit which a multicast message from the host reaches; and
a file name managing member configured to manage a file name of the file allocated to the storage unit.
